(19) United States
(12) Patent Application Publication
(10) Pub. No.: US 2026/0319714 A1
(43) Pub. Date: Oct. 15, 2026

(54) TERMINAL DEVICE WITH DOCUMENT PRINTING FUNCTION AND IMAGE PROCESSING METHOD THEREOF

(71) Applicant: PRIMAX ELECTRONICS LTD., Taipei City (TW)

(72) Inventor: Hua-Zhong WU, Beijing City (CN)

(21) Appl. No.: 19/221,585

(22) Filed: May 29, 2025

(30) Foreign Application Priority Data
Apr. 9, 2025 (CN) 202510438791.4

(51) Int. Cl. G06F 3/12

(52) U.S. Cl. CPC G06F 3/1204; G06F 3/1256

(57) ABSTRACT

A terminal device with a document printing function is provided. The terminal device includes an image reading unit, a processing unit, a user interface display and an image output unit. The image reading unit acquires an original image. The processing unit receives an image processing command, and the processing unit transmits the image processing command and the original image to a cloud computing platform. The cloud computing platform uses an image processing model to modify the original image according to the image processing command. After the original image is modified, a modified image is generated, and the modified image is sent from the cloud computing platform back to the processing unit. The original image and the modified image are displayed on the user interface display. The image output unit prints the modified image on a medium.

### FIELD OF THE INVENTION

The present invention relates to a terminal device with a document printing function.

### BACKGROUND OF THE INVENTION

Nowadays, the applications of generative artificial intelligence technologies are mainly focused on mobile internet terminals (e.g., smart phones) and desktop network terminals (e.g., personal computers). In other words, the application scenarios of generative artificial intelligence technologies are limited.

Generally, multifunction printers, copiers and scanners are common offices machines with printing functions. However, when the office machines process images, they usually rely solely on their built-in computing power. That is, cloud-based or more powerful AI computing resources cannot be fully utilized.

Therefore, it is important to provide a terminal device with an improved document printing function and an image processing method for the terminal device.

### SUMMARY OF THE INVENTION

An object of the present invention provides a terminal device with an improved document printing function and an image processing method for the terminal device.

The other objects and advantages of the present invention will be understood from the disclosed technical features.

In accordance with an aspect of the present invention, a terminal device with a document printing function is provided. The terminal device includes an image reading unit, a processing unit, a user interface display and an image output unit. The image reading unit acquires an original image. The processing unit receives at least one image processing command, and the processing unit transmits the at least one image processing command and the original image to a cloud computing platform. The cloud computing platform includes at least one image processing model. The at least one image processing model modifies the original image according to the at least one image processing command. After the original image is modified, a modified image is generated, and the modified image is sent from the cloud computing platform back to the processing unit. The original image and the modified image are displayed on the user interface display. The image output unit prints the modified image on a medium.

In an embodiment, the original image at least includes a background part, a stamp part or a handwriting part.

In an embodiment, the at least one image processing command includes a background removal command, a stamp removal command or a handwriting removal command.

In an embodiment, the terminal device further includes a network connection unit, and the terminal device is connected with the cloud computing platform through the network connection unit.

In an embodiment, the terminal device further includes a temporary storage unit, and the at least one image processing command, the original image, and the modified image are stored in the temporary storage unit.

In an embodiment, the terminal device further includes a user interface input unit, and the at least one image processing command is triggered and transmitted through the user interface input unit.

In an embodiment, the terminal device further includes a non-volatile random access memory unit. An account information and a password information required to log in to the cloud computing platform are accessed by the non-volatile random access memory unit.

In an embodiment, the image reading unit includes a charge-coupled device (CCD) sensor or a contact image sensor (CIS) sensor.

In an embodiment, the processing unit is a digital signal processor (DSP), a central processing unit (CPU) or a graphic processing unit (GPU).

In an embodiment, the temporary storage unit is a double data rate synchronous dynamic random access memory.

In an embodiment, the user interface input unit is a virtual key or a physical key.

In an embodiment, the user interface display is a touch screen.

In an embodiment, the image output unit is a printing device.

In accordance with another aspect of the present invention, an image processing method for terminal device with a document printing function is provided. The terminal device includes an image reading unit, a processing unit, a user interface display and an image output unit. The image processing method includes the following steps. Firstly, the image reading unit acquires an original image. Then, the processing unit receives at least one image processing command. Then, the processing unit transmits the original image and the at least one image processing command to a cloud computing platform, wherein the cloud computing platform includes at least one image processing model. Then, the processing unit acquires a modified image from the cloud computing platform. The modified image is generated after the at least one image processing model modifies the original image according to the at least one image processing command. Then, the original image and the modified image are displayed on the user interface display. Afterwards, the image output unit prints the modified image on a carrier.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the architecture of a cloud collaborative image processing system according to an embodiment of the present invention;

FIG. 2 is a flowchart illustrating a mode selection method for the terminal device with a document printing function according to the present invention;

FIG. 3 illustrates an image processing flow of the terminal device in the intelligent mode;

FIGS. 4A and 4B schematically a first implementation example of performing the image processing task by the terminal device of the present invention in the intelligent mode;

FIGS. 5A and 5B schematically a second implementation example of performing the image processing task by the terminal device of the present invention in the intelligent mode;

FIGS. 6A and 6B schematically a third implementation example of performing the image processing task by the terminal device of the present invention in the intelligent mode;

FIGS. 7A, 7B and 7C schematically illustrate a control panel of the terminal device with the document printing function during a mode selection process; and

FIGS. 8A to 8F schematically illustrate the user interface display of the terminal device of the present invention when the terminal device is in the intelligent mode to process images.

### DETAILED DESCRIPTION OF THE PREFERRED EMBODIMENT

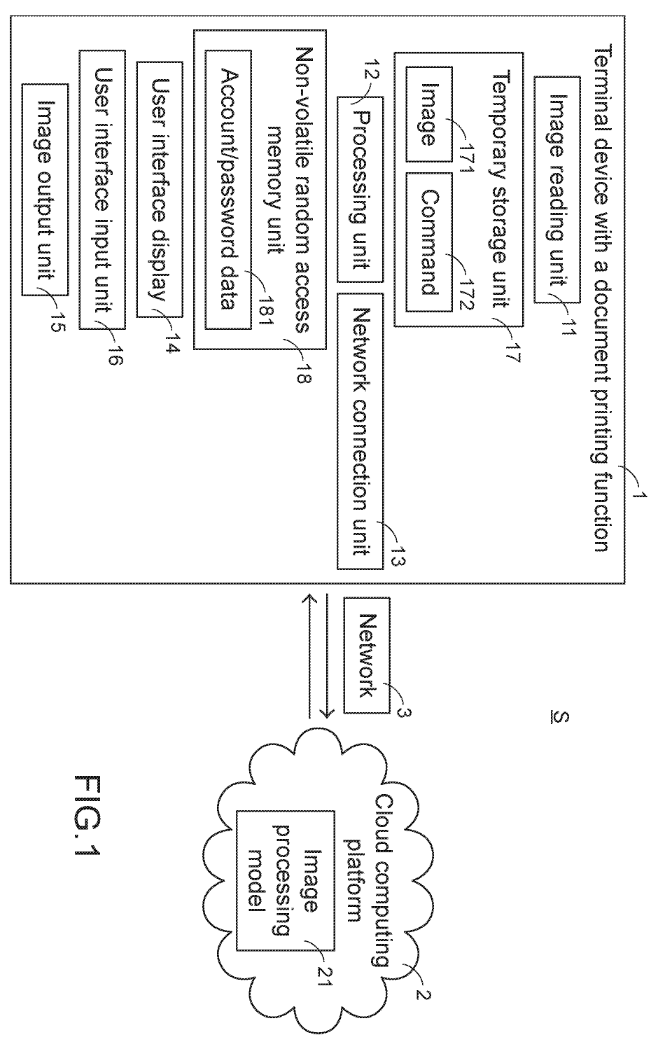

FIG. 1 schematically illustrates the architecture of a cloud collaborative image processing system according to an embodiment of the present invention. As shown in FIG. 1, the cloud collaborative image processing system S includes a terminal device with a document printing function 1 (referred to as” terminal device 1” hereinafter), a cloud computing platform 2, and a network 3. The terminal device 1 and the cloud computing platform 2 are in communication with each other through the network 3. The terminal device 1 is used to obtain an original image OI and transmit image data and processing commands to a cloud computing platform 2. In addition, the terminal device 1 receives and outputs a modified image RI processed by the cloud computing platform 2.

In an embodiment, the terminal device 1 includes an image reading unit 11, a processing unit 12, a network connection unit 13, a user interface display 14, an image output unit 15, a user interface input unit 16 and a temporary storage unit 17.

The image reading unit 11 includes an image sensing element, e.g., a charge-coupled device (CCD) sensor or a contact image sensor (CIS) sensor. The image reading unit 11 is used for converting contents of physical documents or objects into digital image signals. Preferably but not exclusively, the image reading unit 11 is a scanning device.

The processing unit 12 is a computing processor, e.g., a digital signal processor (DSP), a central processing unit (CPU), or a graphic processing unit (GPU). The processing unit 12 receives at least one image processing command that is inputted by the user through the user interface input unit 16. In addition, the processing unit 12 transmits the data of the original image OI and the at least one image processing command to the cloud computing platform 2 through the network connection unit 13. The processing unit 12 also receives the modified image RI that is sent back from the cloud computing platform 2. Furthermore, the processing unit 12 controls the operations of the user interface display 14 and the image output unit 15.

The terminal device 1 is connected to the network 3 through the network connection unit 13. For example, the network connection unit 13 is a wired network interface or a wireless network interface.

The user interface display 14 is a user interface (e.g., as a display device or a touch screen) for providing a function of previewing an image. The original image OI and the modified image RI can be displayed on the user interface display 14.

The image output unit 15 is an image output device (e.g., a printing device) for printing an image on a medium.

The user interface input unit 16 is used for the user to operate the terminal device 1. In addition, the user interface input unit 16 is used for the user to input commands. Preferably but not exclusively, the user interface input unit 16 is a virtual key, a physical key or a microphone device.

The terminal device 1 further includes the temporary storage unit 17 and a non-volatile random access memory unit 18. For example, the temporary storage unit 17 is a double data rate synchronous dynamic random access memory (DDR Memory) for temporarily storing images 171 and commands 172. The non-volatile random access memory unit 18 is used for storing account data and password data 181 required to log in to the cloud computing platform 2 to ensure the security of system operation.

The main function of the cloud computing platform 2 is to receive the original image OI and the processing commands from the terminal device 1. Furthermore, the cloud computing platform 2 uses at least one image processing model 21 to process the original image OI and generate the modified image RI. The image processing model 21 is a trained artificial intelligence model that can perform various image processing tasks (e.g., object recognition, image enhancement, image restoration, image style conversion) and specified task processing operations (e.g., the operation of removing stamp parts, handwriting parts or background parts). After the processing operation is completed, the cloud computing platform 2 will send the modified image RI back to the terminal device 1 through the network 3.

The network 3 is a data transmission medium. The network 3 is responsible for the transmission of data and commands between terminal device 1 and the cloud computing platform 2. Preferably but not exclusively, the network 3 is an Internet or a local area network. The bandwidth and delay of the network 3 will affect the speed and efficiency of the image processing operation.

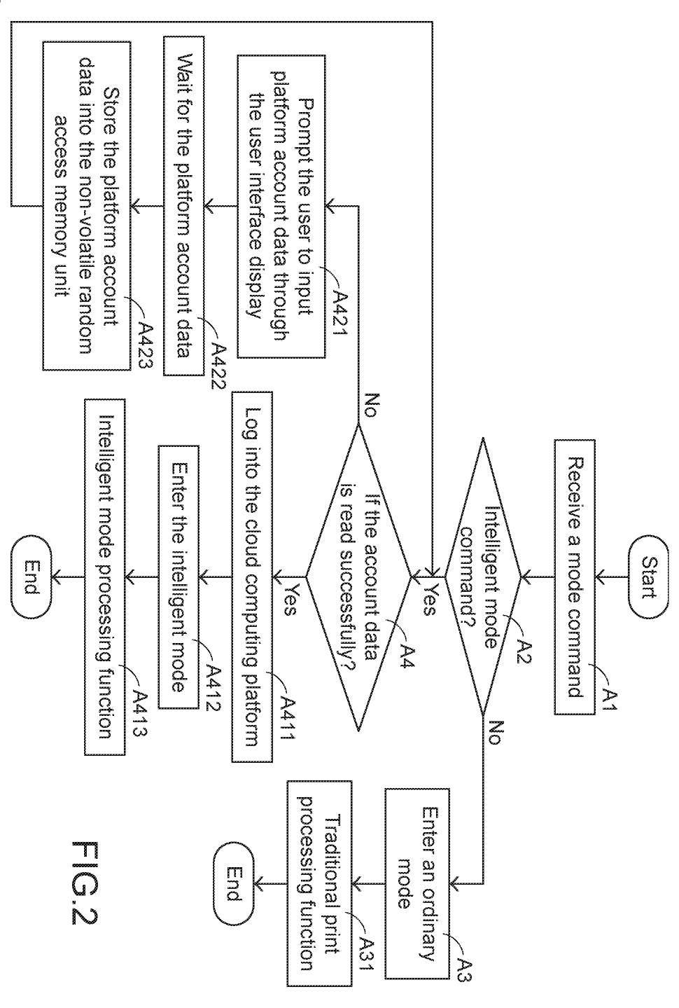

Please refer to FIG. 2. FIG. 2 is a flowchart illustrating a mode selection method for the terminal device with a document printing function according to the present invention. For example, the terminal device 1 is a multifunction printer. The mode selection method includes the following steps.

Firstly, in a step A1, the terminal device 1 receives a mode command. The user can input the mode command through a touch screen, a physical key, a voice input or any another appropriate input approach to instruct the terminal device 1 to enter an ordinary mode or an intelligent mode.

After the terminal device 1 receives the mode command, a step A2 of the mode selection method is performed to judge whether the mode command is an intelligent mode command.

If the judging condition of the step A2 is not satisfied, it means that the user selects the ordinary mode. Then, a step A3 is performed. The terminal device 1 enters the ordinary mode. Then, a step A31 is performed to execute a traditional print processing function. After the step A31 is completed, the flowchart is ended.

In this context, the term “ordinary mode” is the basic function of the terminal device 1 when the terminal device 1 is not connected with the cloud computing platform 2. In the ordinary mode, the terminal device 1 provides printing, scanning, faxing and any other appropriate office machine functions. In case that the user only needs to perform basic document processing tasks or the network environment is unstable, the ordinary mode is feasible.

If the judging condition of the step A2 is satisfied, it means that the user selects the intelligent mode. Consequently, the terminal device 1 enters the intelligent mode processing flow. In order to ensure that the user has the authority to use the intelligent function, the terminal device 1 will execute an account verification procedure.

Then, a step A4 is performed. The terminal device 1 intends to read an account data for the cloud computing platform 2 from the built-in non-volatile random access memory unit 18.

If the judging condition of the step A4 indicates that the account data can be read successfully, a step A411 is performed to log into the cloud computing platform 2. Then, the terminal device 1 enters the intelligent mode (Step A412), and an intelligent mode processing function is implemented (Step A413).

If the judging condition of the step A4 indicates that the account data cannot be read successfully, the user is prompted to input a platform account password data through the user interface display 14 (Step A421). After the user inputs the platform account data through the user interface input unit 16 (e.g., a touch screen or a physical keyboard), the cloud computing platform 2 waits for receiving the platform account data (Step A422). After the platform account data is received successfully, the platform account data is stored into the non-volatile random access memory unit 18 of the terminal device 1 (Step A423).

This step makes it easier for the user to log into the cloud platform next time and ensures data security. Consequently, the inconvenience and potential risks caused by repeated input can be avoided. After obtaining the account data, the terminal device 1 performs the step of logging into the cloud computing platform 2 again. That is, the terminal device 1 transmits the account data, the password data and associated information to the cloud computing platform 2 through the network connection unit 13 for identity verification. After successful verification, the cloud computing platform 2 returns a login success message, and the terminal device 1 enters the intelligent mode.

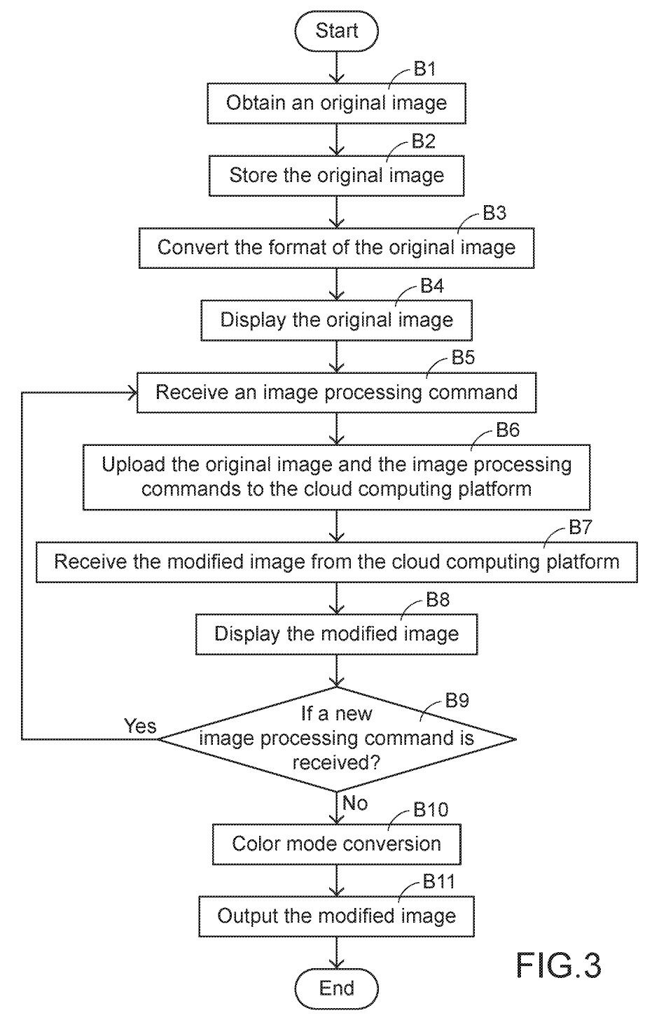

An image processing flow of the terminal device 1 in the intelligent mode will be described as follows. FIG. 3 illustrates an image processing flow of the terminal device in the intelligent mode.

Firstly, in a step B1, an original image OI is obtained. In this step, the terminal device 1 obtains the original image OI through its built-in image reading unit 11.

Then, in a step B2, the original image OI is stored. After the terminal device 1 with the document printing function stores the obtained original image OI in the built-in temporary storage unit 17, a next step is performed.

Then, in a step B3, the format of the original image OI is converted. The terminal device 1 can selectively convert the format of the original image OI. The purpose of the format conversion is to convert the original image into a format suitable for subsequent processing procedures. For example, the format conversion include the processes of compressing the image, adjusting the image size, converting the image color mode, etc.

Then, in a step B4, the original image OI is displayed. The terminal device 1 will allow the user interface display 14 to display the original image OI.

Then, in a step B5, an image processing command is received. For example, the user inputs the image processing command through the user interface input unit 16 of the terminal device 1. Preferably but not exclusively, the image processing command is in the form of texts, voices or gestures. The contents of the image processing command contain specified processing requirements such as stamp removal, handwriting removal, background removal, image enhancement, or image style transfer.

Then, in a step B6, the original image OI and the image processing command are uploaded to the cloud computing platform 2. In this step, the processing unit 12 of the terminal device 1 transmits the data of the original image OI and the user-input image processing command to the cloud computing platform 2 through the network connection unit 13. After receiving the data of the original image OI and the image processing command from the terminal device 1, the cloud computing platform 2 enters an image processing stage. According to the image processing commands inputted by the user, the cloud computing platform 2 utilizes at least one image processing model 21 to process the original image OI.

After the image processing stage is completed, a step B7 is performed. Consequently, the modified image from the cloud computing platform 2 is acquired. In this step, the modified image RI after processed is sent back to the processing unit 12 of the terminal device 1.

After receiving the modified image RI from the cloud computing platform 2, the terminal device 1 performs a step B8. In the step B8, the modified image RI is displayed. The modified image RI is displayed on the user interface display 14 of the terminal device 1 for the user to preview.

Then, a step B9 is performed to judge whether a new image processing command is received. That is, the terminal device 1 judges whether a new image processing command inputted by the user is received. If the judging condition of the step B9 is satisfied, then return to a step B5 of receiving image processing command. Whereas, if the judging condition of the step B9 is not satisfied, a color mode conversion is performed (Step B10) and the result of the modified image is outputted (Step B11). The terminal device 1 can selectively perform the color mode conversion on the modified image. The purpose of the color mode conversion is to convert the modified image into a color mode suitable for the output device. The terminal device 1 outputs the modified image RI through the image output unit 15. Preferably but not exclusively, the output method is a printing method.

Some implementation examples of the control method in image processing performance will be described as follows.

### Example 1: Stamp Removal

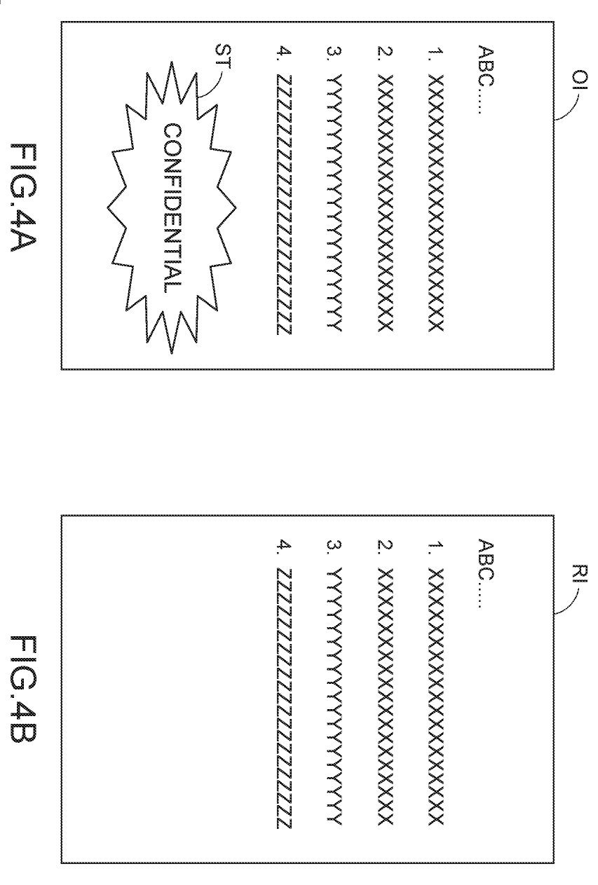

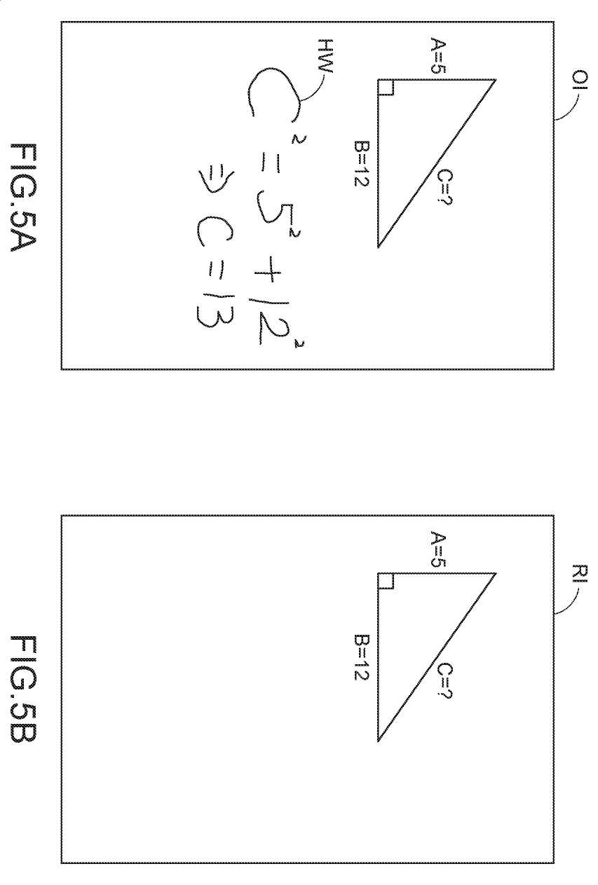

Please refer to FIGS. 1, 4A and 4B. FIGS. 4A and 4B schematically a first implementation example of performing the image processing task by the terminal device of the present invention in the intelligent mode. Firstly, a document with a stamp part ST is placed on a scanning platform (not shown) of the terminal device 1 by the user. Then, the user selects a scanning function through the user interface input unit 16 of the terminal device 1. After the image reading unit 11 of the terminal device 1 scans the document, the scanned original image OI is stored in the temporary storage unit 17. Then, the user inputs the image processing command “remove the stamp part”. The original image OI and the image processing command are transmitted from the terminal device 1 to the cloud computing platform 2 through the processing unit 12. According to the image processing command inputted by the user, the cloud computing platform 2 uses the stamp recognition and removal technology to remove the stamp part ST from the original image OI. The area left after the removal is repaired, and thus the modified image RI is generated. Then, the modified image RI without the stamp part ST is sent back from the cloud computing platform 2 to the processing unit 12 of the terminal device 1. The modified image RI without the stamp part ST is displayed on the user interface display 14 of the terminal device 1. After the user confirms that it is correct, the modified image RI without the stamp part ST is printed to the user by the image output unit 15 of the terminal device 1.

### Example 2: Handwriting Removal

Please refer to FIGS. 1, 5A and 5B. FIGS. 5A and 5B schematically a second implementation example of performing the image processing task by the terminal device of the present invention in the intelligent mode. Firstly, a notebook with a handwriting part HW is placed on a scanning platform (not shown) of the terminal device 1 by the user. After the image reading unit 11 of the terminal device 1 scans the notebook, the scanned original image OI is stored in the temporary storage unit 17. Then, the user inputs the image processing command “remove the handwriting part”. The original image OI and the image processing command are transmitted from the terminal device 1 to the cloud computing platform 2 through the processing unit 12. According to the image processing command inputted by the user, the cloud computing platform 2 uses the handwriting recognition and removal technology to remove the handwriting part HW from the original image OI. The area left after the removal is repaired, and thus the modified image RI is generated. Then, the modified image RI without the handwriting part HW is sent back from the cloud computing platform 2 to the processing unit 12 of the terminal device 1. The modified image RI without the handwriting part HW is displayed on the user interface display 14 of the terminal device 1. After the user confirms that it is correct, the modified image RI without the handwriting part HW is transmitted from the image output unit 15 of the terminal device 1 to a connected computer (not shown) for storage.

### Example 3: Background Removal

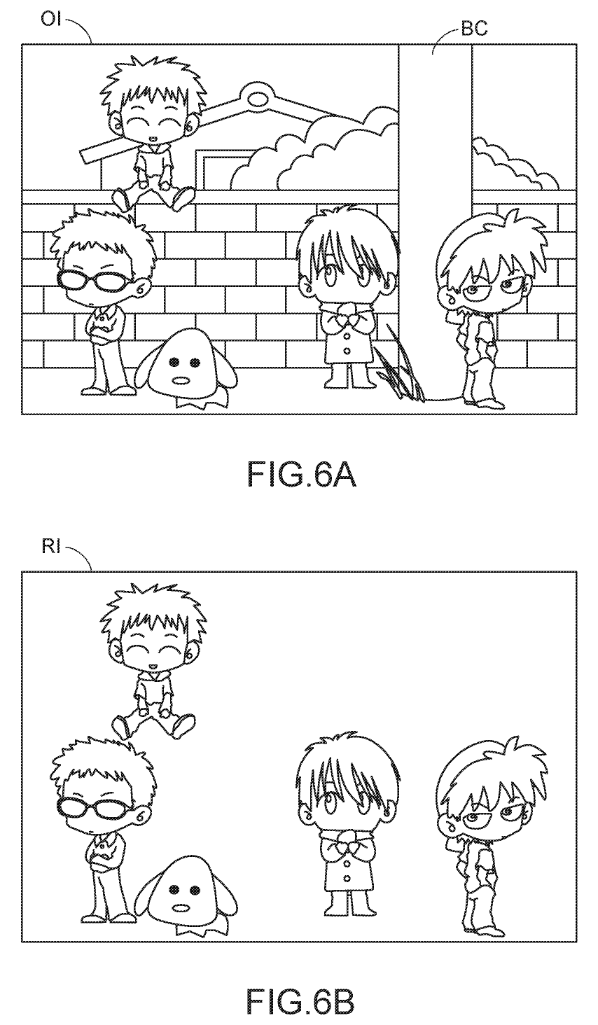

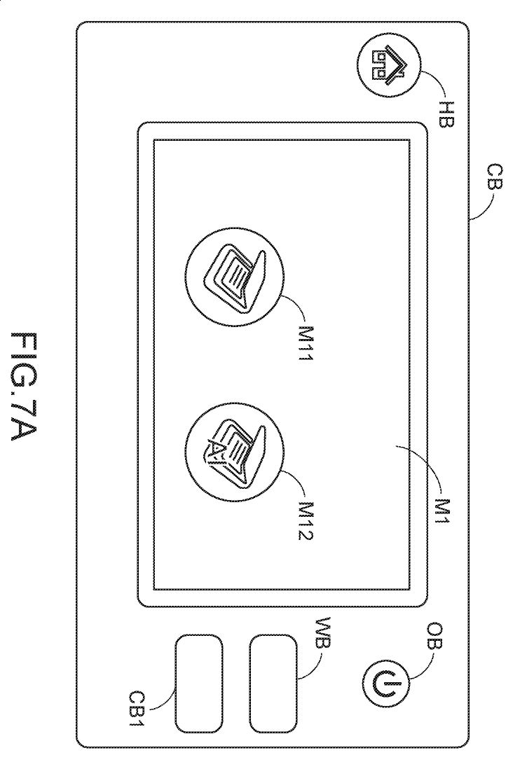

Please refer to FIGS. 1, 6A and 6B. FIGS. 6A and 6B schematically a third implementation example of performing the image processing task by the terminal device of the present invention in the intelligent mode. Firstly, a portrait photo with a background part BC is placed on a scanning platform (not shown) of the terminal device 1 by the user. After the image reading unit 11 of the terminal device 1 scans the photo, the scanned original image OI is stored in the temporary storage unit 17. Then, the user inputs the image processing command “remove the background part”. The original image OI and the image processing command are transmitted from the terminal device 1 to the cloud computing platform 2 through the processing unit 12. According to the image processing command inputted by the user, the cloud computing platform 2 uses the background recognition and removal technology to remove the background part BC from the original image OI. Consequently, the modified image RI is generated. Then, the modified image RI without the background part BC is sent back from the cloud computing platform 2 to the processing unit 12 of the terminal device 1. The modified image RI without the background part BC is displayed on the user interface display 14 of the terminal device 1. Meanwhile, according to the user’s selection, another background part can be placed on the modified image or the modified image can be printed out.

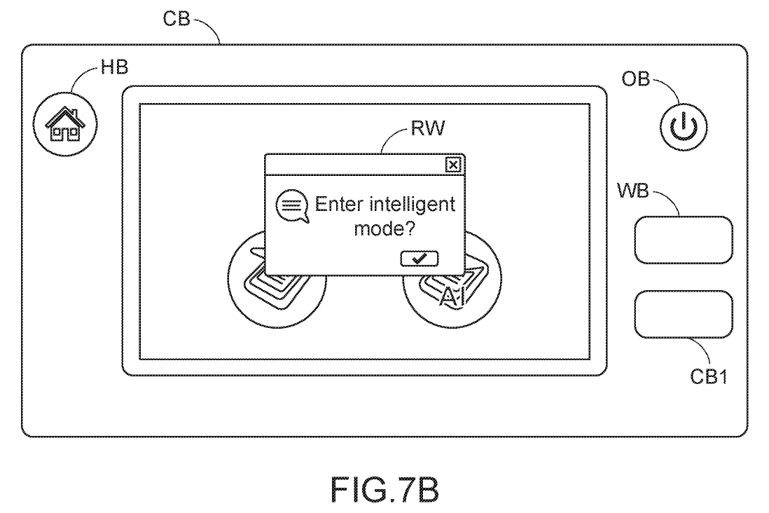

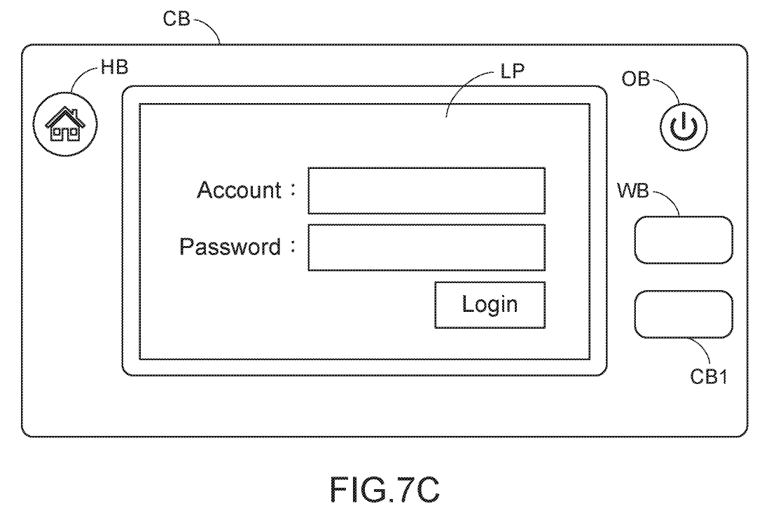

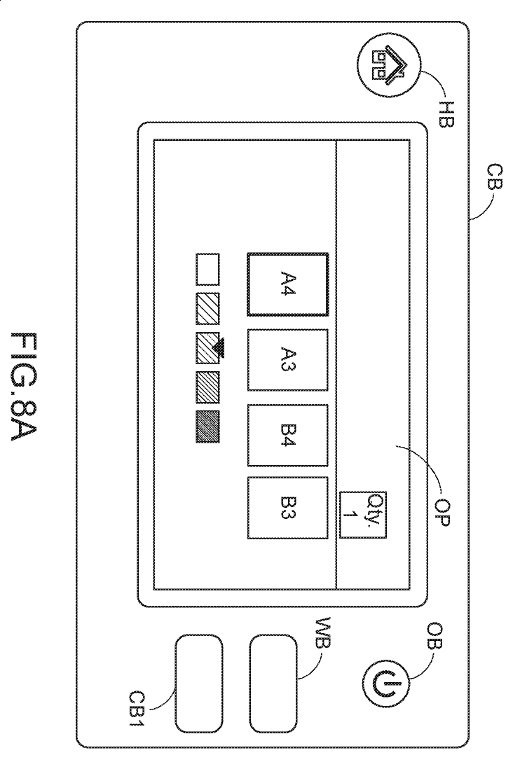

A control panel for the terminal device 1 of the present invention will be described in more detail as follows. FIGS. 7A, 7B and 7C schematically illustrate a control panel of the terminal device with the document printing function during a mode selection process. In an embodiment, the control panel CB includes the user interface input unit 16 and the user interface display 14. The user interface input unit 16 includes a home key HB, a grayscale key WB, a color key CB1 and a start key OB.

In FIG. 7A, a home page M1 is displayed on the user interface display 14, and the home page M1 at least contains an ordinary mode icon M11 and an intelligent mode icon M12.

Please refer to FIG. 7B. After the user clicks the intelligent mode icon M12, the user interface display 14 pops up a prompt window RW to remind the user that the terminal device 1 is about to enter the intelligent mode. After the user clicks the confirmation key, the terminal device 1 enters the intelligent mode.

Please refer to FIG. 7C. If the terminal device 1 cannot read the account data, the user interface display 14 pops up the login page LP for the user to input the account and password information.

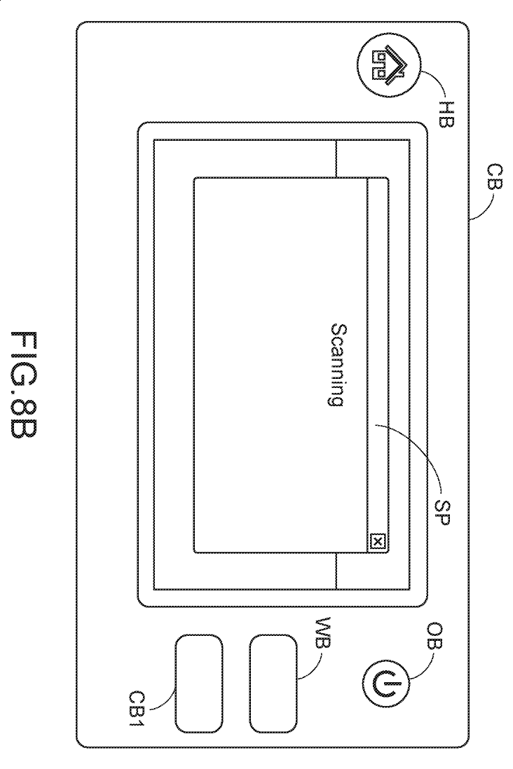

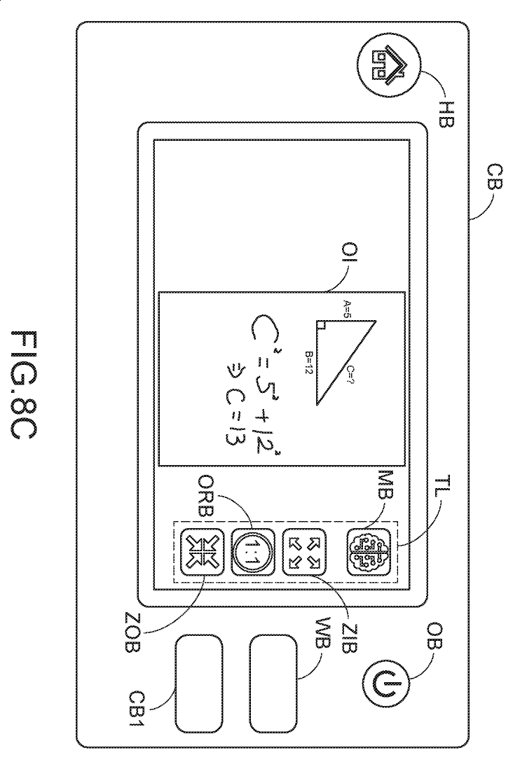

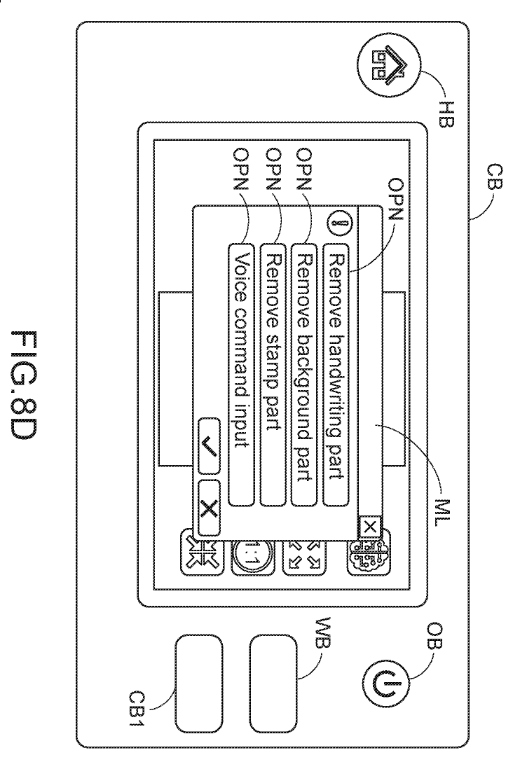

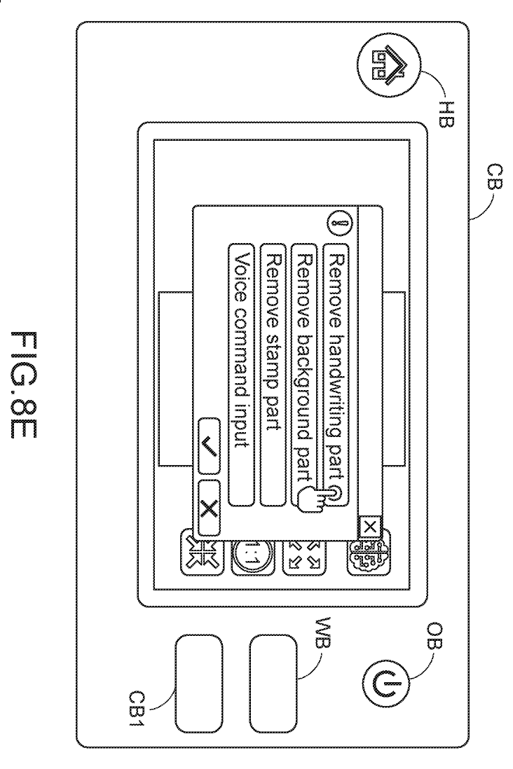

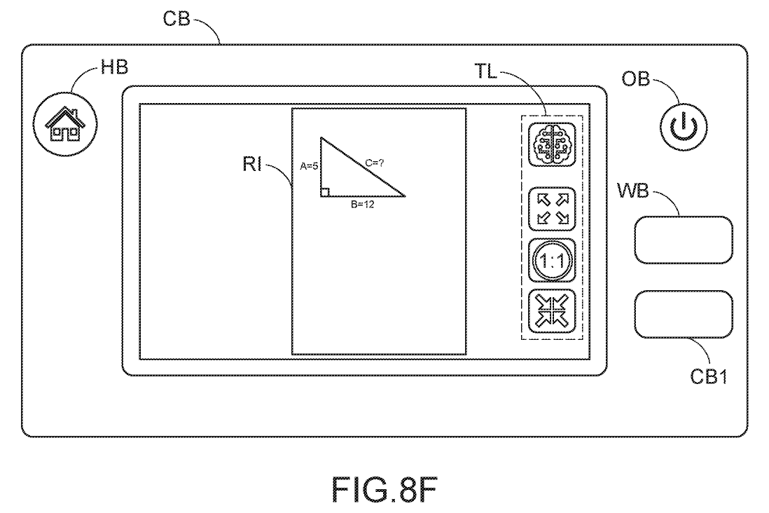

FIGS. 8A - 8F schematically illustrate the user interface display of the terminal device of the present invention when the terminal device is in the intelligent mode to process images.

Please refer to FIG. 8A. After the terminal device 1 enters the intelligent mode, an operation page OP is displayed on the user interface display 14. The operation page OP includes a size setting icon, an image tone setting icon, a copy number setting icon, or any other appropriate setting icon.

Please refer to FIG. 8B. When the user starts scanning the original image OI, an image SP being scanned is displayed on the user interface display 14.

Please refer to FIG. 8C. After the scanning operation is completed, the original image (OI) and a toolbar (TL) are displayed on the user interface display 14. The original image OI includes at least a background part BC, a stamp part ST or a handwritten part HW. The toolbar TL includes a zoom-out button ZOB, a zoom-in button ZIB, an original scale button ORB and a command button MB. The user can examine the original image OI through the zoom-in button ZIB, the original scale button ORB and the zoom-out button ZOB on the toolbar TL.

Please refer to FIG. 8D. After the user presses the command button MB, a command list ML is displayed on the user interface display 14 for the user to select. The command list ML contains a plurality of options OPN, e.g., a handwriting removal option, a background removal option, a stamp removal option or a voice command input option.

For example, as shown in FIG. 8E, the user selects the handwriting removal option. Consequently, the terminal device 1 performs the associated image processing task.

Please refer to FIG. 8F. After the image processing task is completed, the modified image RI is displayed on the user interface display 14. Meanwhile, the user can use the zoom-in button ZIB, the original scale button ORB and the zoom-out button ZOB on the toolbar TL to examine the modified image RI again.

From the above descriptions, the present invention provides a terminal device with a document printing function and an image processing method. In accordance with a feature, the terminal device is connected to the cloud computing platform to perform the complicated image processing tasks. In addition, the modified image can be directly printed to the user through the terminal device.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A terminal device with a document printing function, the terminal device comprising:
an image reading unit acquiring an original image;
a processing unit receiving at least one image processing command, and transmitting the at least one image processing command and the original image to a cloud computing platform, wherein the cloud computing platform comprises at least one image processing model, and the at least one image processing model modifies the original image according to the at least one image processing command, wherein after the original image is modified, a modified image is generated, and the modified image is sent from the cloud computing platform back to the processing unit;
a user interface display, wherein the original image and the modified image are displayed on the user interface display; and
an image output unit printing the modified image on a medium.

2. The terminal device according to claim 1, wherein the original image at least comprises a background part, a stamp part or a handwriting part.

3. The terminal device according to claim 1, wherein the at least one image processing command comprises a background removal command, a stamp removal command or a handwriting removal command.

4. The terminal device according to claim 1, wherein the terminal device further comprises a network connection unit, and the terminal device is connected with the cloud computing platform through the network connection unit.

5. The terminal device according to claim 1, wherein the terminal device further comprises a temporary storage unit, and the at least one image processing command, the original image, and the modified image are stored in the temporary storage unit.

6. The terminal device according to claim 1, wherein the terminal device further comprises a user interface input unit, and the at least one image processing command is triggered and transmitted through the user interface input unit.

7. The terminal device according to claim 1, wherein the terminal device further comprises a non-volatile random access memory unit, wherein an account information and a password information required to log in to the cloud computing platform are accessed by the non-volatile random access memory unit.

8. The terminal device according to claim 1, wherein the image reading unit includes a charge-coupled device (CCD) sensor or a contact image sensor (CIS) sensor.

9. The terminal device according to claim 1, wherein the processing unit is a digital signal processor (DSP), a central processing unit (CPU) or a graphic processing unit (GPU).

10. The terminal device according to claim 5, wherein the temporary storage unit is a double data rate synchronous dynamic random access memory.

11. The terminal device according to claim 6, wherein the user interface input unit is a virtual key or a physical key.

12. The terminal device according to claim 1, wherein the user interface display is a touch screen.

13. The terminal device according to claim 1, wherein the image output unit is a printing device.

14. An image processing method for terminal device with a document printing function, the terminal device comprising an image reading unit, a processing unit, a user interface display and an image output unit, the image processing method comprising steps of:
the image reading unit acquiring an original image;
the processing unit receiving at least one image processing command;
the processing unit transmitting the original image and the at least one image processing command to a cloud computing platform, wherein the cloud computing platform comprises at least one image processing model;
the processing unit acquiring a modified image from the cloud computing platform, wherein the modified image is generated after the at least one image processing model modifies the original image according to the at least one image processing command;
the user interface display displaying the original image and the modified image; and
the image output unit printing the modified image on a medium.

15. The image processing method according to claim 14, wherein after the terminal device acquires the original image, the image processing method further comprises steps of storing the original image and converting a format of the original image.

16. The image processing method according to claim 14, wherein after the terminal device acquires the modified image, the image processing method further comprises a step of displaying the modified image.

17. The image processing method according to claim 16, wherein after the terminal device displays the modified image, the image processing method further comprises a step of judging whether the at least one image processing command is received, wherein if the at least one image processing command is received, the step of receiving the at least one image processing command by the processing unit is performed again.

18. The image processing method according to claim 17, wherein if the terminal device does not receive the at least one image processing command again, the image processing method further comprises a step of performing a color mode conversion on the modified image.

19. The image processing method according to claim 14, wherein original image at least comprises a background part, a stamp part or a handwriting part.

20. The image processing method according to claim 14, wherein the at least one image processing command comprises a background removal command, a stamp removal command or a handwriting removal command.
